(19) United States
(12) Patent Application Publication
(10) Pub. No.: US 2016/0012562 A1
(43) Pub. Date: Jan. 14, 2016

(54) IMAGE PROCESSING APPARATUS AND IMAGE PROCESSING METHOD

(71) Applicant: CANON KABUSHIKI KAISHA, Tokyo (JP)

(72) Inventor: Masato Sanno, Tokyo (JP)

(21) Appl. No.: 14/793,054

(22) Filed: Jul. 7, 2015

(30) Foreign Application Priority Data
Jul. 8, 2014 (JP) 2014-140909

(51) Int. Cl. G06T 1/00; H04N 5/232; H04N 9/73; G06T 9/00; H04N 5/77

(52) U.S. Cl. CPC G06T 1/0007; G06T 9/00; H04N 5/772; H04N 9/735; H04N 5/23293; H04N 5/23296; G06T 2200/21; G06T 2200/28; G06T 2207/10004; G06T 2207/10016; G06T 2207/10144; H04N 2201/3252; H04N 2201/3247; H04N 2201/3274; H04N 2101/00

(57) ABSTRACT

A device includes a generating unit configured to acquire RAW data for a moving image and RAW data for a still image, a calculation unit configured to calculate an evaluation value from the RAW data for the still image, an encoding unit configured to encode the RAW data for the moving image to moving image data, a recording unit configured to record the encoded moving image data, and a control unit configured to, in response to an instruction to record a still image, exercise control to record moving image data corresponding to a predetermined time period before the recording instruction. The encoding unit is configured to encode the moving image data, by applying an evaluation value calculated from the RAW data for the still image by the calculation unit to the RAW data for the moving image.

### BACKGROUND OF THE INVENTION

1. Field of the Invention

The present invention relates to an image processing apparatus and an image processing method capable of previously shooting a moving image before still image capture at a time when a still image is shot, to record the moving image and the still image simultaneously.

2. Description of the Related Art

Conventionally, a technique is known that prevents a user from having a feeling of strangeness produced due to a color change in a moving picture when a still image is captured during shooting of a moving image. The strangeness is prevented from being felt, by changeover to white balance (WB) for still image shooting. For example, Japanese Patent Application Laid-Open No. 10-174113 discusses a technique of narrowing the control range of WB in a case where it is determined that the change of the still image recording from off to on is repeated at least once in the predetermined time period, as compared with a case where the change is not repeated in a predetermined time period.

During moving image recoding, control is performed following a subject up to an adequate WB position. Accordingly, if the adequate WB position for the subject is located outside of a control range due to the narrowed control range of WB according to the conventional method, suitable WB may not be obtained for a scene of a moving image in some cases. When a still image is shot immediately after moving image recording under such a situation, the still image differs in color tone from the moving image recorded immediately before the shooting of the still image. Therefore, when the shot moving image is compared with the still image, strangeness is felt.

### SUMMARY OF THE INVENTION

One of the aspects of the present invention is directed to making it possible to shoot a still image and a moving image that are not different from each other in color tone and that do not cause a user to feel strangeness, even when the moving image is shot immediately before shooting of the still image.

According to one aspect of the present invention, an image processing device includes an acquisition unit configured to acquire RAW data for a moving image and RAW data for a still image, a calculation unit configured to calculate an evaluation value from the RAW data for the still image, an encoding unit configured to encode the RAW data acquired by the acquisition unit for the moving image to moving image data, a recording unit configured to record the encoded moving image data, and a control unit configured to, in response to an instruction to record a still image, exercise control to record the moving image data obtained during a predetermined time period before the recording instruction. The encoding unit is configured to encode the RAW data for the moving image into the moving image data by applying an evaluation value calculated from the RAW data for the still image by the calculation unit, to the RAW data for the moving image.

According to another aspect of the invention, moving image data is generated later based on an evaluation value of a still image as described above. Therefore, even if a moving image is shot immediately before shooting of a still image, the moving image and the still image can be shot without causing feeling of strangeness in color tone between the still image and the moving image.

Further aspect of the invention will become apparent from the following description of exemplary embodiments with reference to the attached drawings.

### BRIEF DESCRIPTION OF THE DRAWINGS

FIG. 1 is a block diagram of image processing device in exemplary embodiments of the present invention.

FIG. 2 is a sequence diagram illustrating a first exemplary embodiment.

FIG. 3 is a flow chart illustrating the first exemplary embodiment.

FIG. 4 is a sequence diagram illustrating a second exemplary embodiment.

FIG. 5 is a flow chart illustrating the second exemplary embodiment.

### DESCRIPTION OF THE EMBODIMENTS

Exemplary embodiments, features and aspects of the present invention will now be described in detail below with reference to the attached drawings.

Hereafter, image processing device in exemplary embodiments of the present invention will be described by taking a digital camera as an example.

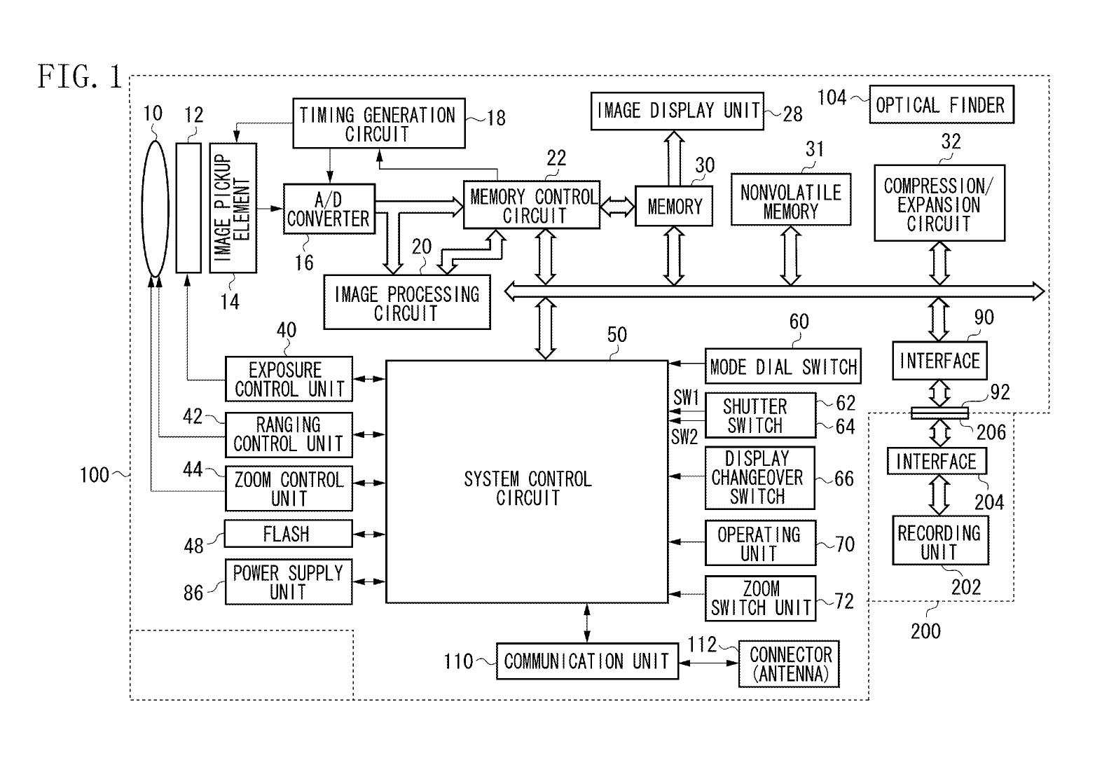

FIG. 1 is a block diagram illustrating a configuration of image processing device in exemplary embodiments of the present invention.

Reference numeral 100 denotes an image processing device. Reference numeral 10 denotes a shooting lens. A mechanical shutter 12 has an aperture function. An image pickup element 14 converts an optical image to an electric signal. An A/D converter 16 converts an analog signal output from the image pickup element 14 into a digital signal.

A timing generation circuit 18 supplies a clock signal and a control signal to the image pickup element 14 and the A/D converter 16. The timing generation circuit 18 is controlled by a memory control circuit 22 and a system control circuit 50. Besides the mechanical shutter 12, it is possible to control storage time by controlling reset timing of the image pickup element 14 in the timing generation circuit 18 as an electronic shutter. The electronic shutter can be used in moving image shooting.

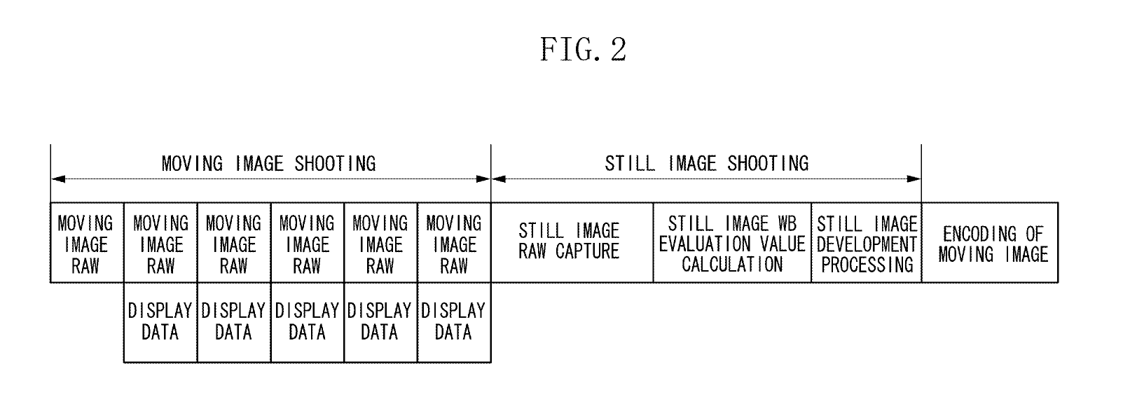

An image processing circuit 20 performs pixel interpolation processing for image enlargement/reduction, color conversion processing, noise reduction processing, and edge enhancement processing on data from the A/D converter 16 or data from the memory control circuit 22. Furthermore, the image processing circuit 20 also performs wavelet conversion processing described below with reference to FIG. 2 on image data from the memory control circuit 22. Besides, the image processing circuit 20 performs predetermined calculation processing by using image data picked up to perform auto white balance (AWB) processing of the through the lens (TTL) method. The image processing circuit 20 obtains calculation result as a WB evaluation value. Further, the image processing circuit 20 performs color conversion of image data based on the calculated WB evaluation value. In addition, the image processing circuit 20 performs predetermined calculation processing by using the picked up image data to calculate an autofocus (AF) evaluation value, an automatic exposure (AE) evaluation value, and a pre-flash (EF) evaluation value for performing AF processing, AE processing, and EF processing of the TTL method. The system control circuit 50 controls an exposure control unit 40 and a ranging control unit 42 according to an algorithm based on the obtained AF evaluation value, AE evaluation value, and EF evaluation value.

The memory control circuit 22 controls the A/D converter 16, the timing generation circuit 18, the image processing circuit 20, a memory 30, and a compression/expansion circuit 32. Data from the A/D converter 16 is written into the memory 30 via the image processing circuit 20 and the memory control circuit 22, or data from the A/D converter 16 is directly written into the memory 30 via the memory control circuit 22.

An image display unit 28 includes a thin film transistor (TFT) liquid crystal display (LCD). Display image data written into the memory 30 is displayed on the image display unit 28 via the memory control circuit 22. If the picked up image data is displayed consecutively by using the image display unit 28, it is possible to implement an electronic finder function. Furthermore, the image display unit 28 can turn on/off the display arbitrarily according to an instruction from the system control circuit 50. When the display is turned off, power consumption in the image processing device 100 can be considerably reduced.

The memory 30 is configured to store shot still images and shot moving images. The memory 30 has a storage capacity enough to store a predetermined number of still images and a moving image of a predetermined time. Therefore, in a case of continuous shooting in which a plurality of still images are shot continuously, it is possible to write a large amount of images into the memory 30 at high speed. Furthermore, the memory 30 can be used as a working area of the system control circuit 50.

A nonvolatile memory 31 includes a flash ROM. A program code to be executed by the system control circuit 50 is written into the nonvolatile memory 31. While reading the program code consecutively, the system control circuit 50 executes the program code. Furthermore, an area configured to store system information and an area configured to store user setting information are provided in the nonvolatile memory 31, so that various kinds of information and setting can be read and reconstructed next time the apparatus is activated.

The compression/expansion circuit 32 compresses/expands image data by using adaptive discrete cosine transform (ADCT). The compression/expansion circuit 32 reads an image stored in the memory 30, performs compression processing or expansion processing, and writes processed data into the memory 30.

The exposure control unit 40 controls the shutter 12 having the aperture function. The exposure control unit 40 is linked to a flash 48 to have a flash control function as well. The ranging control unit 42 controls focusing of the shooting lens 10. A zoom control unit 44 controls zooming of the shooting lens 10. The flash 48 has a function of projecting AF auxiliary light and the flash control function as well. The exposure control unit 40 and the ranging control unit 42 are controlled using the TTL method. The system control circuit 50 controls the exposure control unit 40 and the ranging control unit 42 based on a result of calculation performed on picked up image data by the image processing circuit 20.

The system control circuit 50 controls the entire image processing device 100. Operating units 60, 62, 64, 66, 70 and 72 are provided to input various operation instructions for the system control circuit 50. The operating units 60, 62, 64, 66, 70 and 72 include a switch, a dial, a touch panel, pointing using line of sight detection, or a voice recognition device, or a combination of a plurality of them. These operating units will now be specifically described.

The mode dial switch 60 can be used to switch and set each function mode, such as power supply off, an automatic shooting mode, a shooting mode, a panorama shooting mode, a moving image shooting mode, a reproduction mode, and a personal computer (PC) connection mode. The shutter switch SW1 62 is turned on in the course of operation of a shutter button, and instructs operation start of the AF processing, the AE processing, and the AWB processing.

The shutter switch SW2 64 is turned on when operation of the shutter button is completed. In the case of flash shooting, the image pickup element 14 is exposed to light for an exposure time determined by the AE processing after the EF processing is performed. In the case of the flash shooting, light is emitted for the exposure period. When the exposure period finishes, light is simultaneously shielded by the exposure control unit 40 to finish exposure of the image pickup element 14. A signal read from the image pickup element 14 is written into the memory 30 as image data via the A/D converter 16 and the memory control circuit 22. Development processing using calculation result is performed in the image processing circuit 20 and the memory control circuit 22. Image data is read from the memory 30, and compression is performed in the compression/expansion circuit 32. Then, start of a series of recording processing for writing image data into a recording medium 200 is instructed.

The display changeover switch 66 can switch display on the image display unit 28. Owing to this function, it becomes possible to save power by blocking current supply to the image display unit 28 including the TFT LCD if shooting is performed using an optical finder 104.

The operating unit 70 includes a touch panel and a rotary dial. Furthermore, the operating unit 70 includes a menu button, a set button, a macro button, a multi-screen reproduction page-advance button, a flash setting button, and a single image shooting/continuous shooting/self-timer changeover button. Furthermore, the operating unit 70 includes a menu move plus (+) button, a menu move minus (−) button, a reproduced image move plus (+) button, a reproduced image move minus (−) button, a shooting image quality selection button, an exposure correction button, and a date/time setting button. In addition, the operating unit 70 is used to set various shooting conditions.

The zoom switch unit 72 functions as a zoom operating unit used by the user to instruct a magnification change of a shooting image. Hereafter, the zoom switch unit 72 is also referred to as zoom switch 72. The zoom switch 72 includes a tele switch used to change the image- pickup field angle to the telephoto direction and a wide switch used to change the image-pickup field angle to the wide-angle direction. The zoom switch 72 serves as a trigger for instructing the zoom control unit 44 to change the image-pickup field angle of the shooting lens 10 and operating the optical zoom. Furthermore, the zoom switch 72 serves as a trigger for an electronic zooming change of the image-pickup field angle through pixel interpolation processing, and cut-out processing of an image performed by the image processing circuit 20.

A power supply unit 86 is a primary battery of an alkali battery, a secondary battery such as a NiCd battery, a NiMH battery, or a Li ion battery, or an AC adaptor. An interface 90 is provided for the recording medium 200 such as a memory card or a hard disc. A connector 92 is provided to connect to the recording medium 200 such as a memory card or a hard disc. It is possible to conduct shooting by using only the optical finder 104 without using the electronic finder function provided by the image display unit 28. A communication unit 110 has various communication functions such as a universal serial bus (USB), a local area network (LAN), and wireless communication. A connector (an antenna in the case of wireless communication) 112 connects the image processing device 100 to another device via the communication unit 110.

The recording medium 200 is a memory card or a hard disc. The recording medium 200 includes a recording unit 202 including a semiconductor memory or a magnetic disc, an interface 204 to the image processing device 100, and a connector 206 for connection to the image processing device 100.

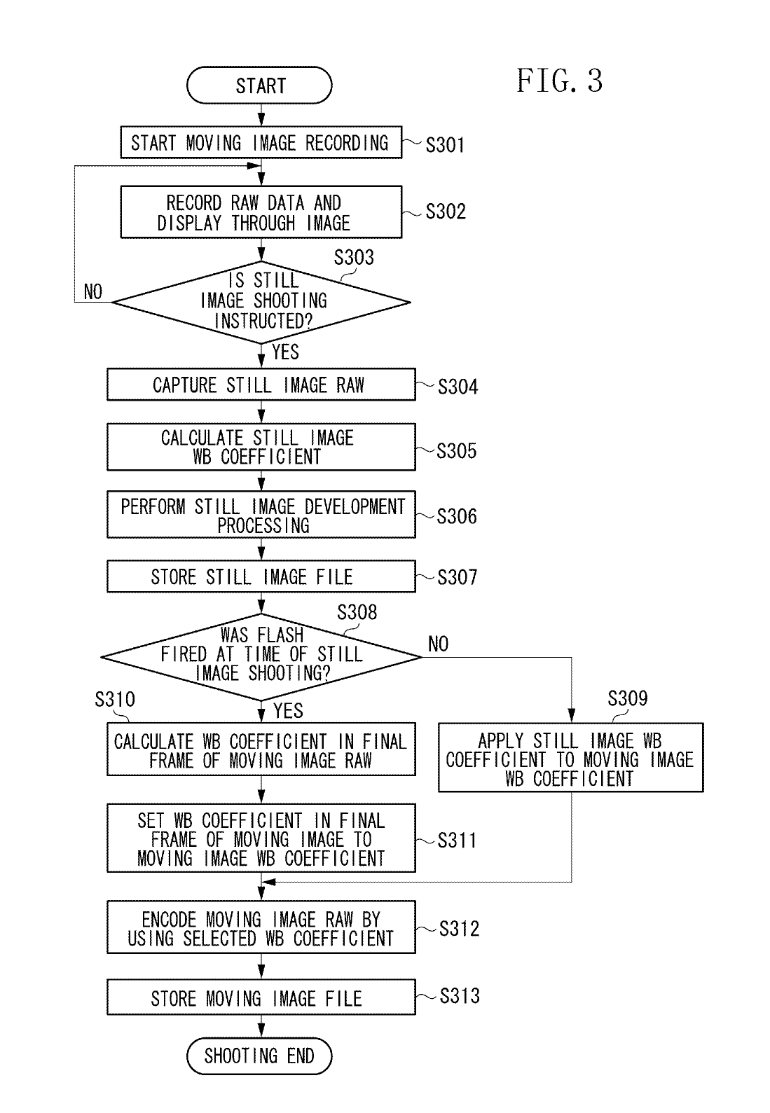

A first exemplary embodiment of the present invention will now be described with reference to a sequence diagram illustrated in FIG. 2 and a flow chart illustrated in FIG. 3.

The first exemplary embodiment is an example in which a moving image is recorded before shooting a still image. For example, two files are recorded as a file of a still image shot when instructed to shoot the still image and a file of a moving image shot several seconds before instructed to shoot the still image.

FIG. 2 is a diagram illustrating a sequence from moving image shooting till still image shooting in the first exemplary embodiment. A first half of the sequence illustrates moving image shooting processing. RAW data for moving image acquired from the image pickup element 14 is stored in the memory 30 temporarily. Here, the RAW data means raw data that remains as obtained from the image pickup element 14 of the digital camera and has not been fully subjected to image processing, or has not been subject to an irreversible compression process. As the next frame, moving image RAW data in a frame next to the frame read from the image pickup element 14 the last time is stored in the memory 30 temporarily. At the same timing, the image processing circuit 20 converts the moving image RAW data in the frame read the last time and temporarily stored, into display data and the image display unit 28 displays the converted data. In this way, moving image RAW data in every frame corresponding to a predetermined time period are stored in the memory 30 until still image shooting is carried out.

If still image shooting is instructed, driving of the image pickup element 14 is changed and a still image RAW data is temporarily stored in the memory 30. Then, the image processing circuit 20 calculates a WB evaluation value for the still image RAW data. Then, development processing of the still image RAW data is performed by using the calculated WB evaluation value, and still image data is generated. The compression/expansion circuit 32 performs compression via the memory 30, and the compressed data is stored in the nonvolatile memory 31. Then, the image processing circuit 20 and the compression/expansion circuit 32 perform encoding processing of moving image RAW data.

A flow in the first exemplary embodiment will now be described with reference to FIG. 3.

First, in step S301, moving image recording is started. In step S302, a through screen is displayed while recording RAW data. In the present exemplary embodiment, if it becomes difficult to record moving image RAW data in a buffer included in the memory 30, the moving image RAW data is recorded by overwriting on old RAW data in a previously recorded order. The through image display is continued while recording the moving image RAW data until still image shooting is instructed in step S303. When still image shooting is instructed (YES in step S303), in step S304, the RAW data for the still image is recorded in the buffer included in the memory 30. In step S305, the image processing circuit 20 calculates a WB coefficient as to the RAW data for the still image. In step S306, the image processing circuit 20 and the compression/expansion circuit 32 convert the RAW data for the still image to an image format such as Joint Photographic Experts Group (JPEG) by using the calculated WB coefficient. Then, in step S307, the still image is stored in the nonvolatile memory 31. If the flash is not fired at the time of still image shooting (NO in step S308), then in step S309, the WB coefficient obtained at the time of still image is applied to the WB coefficient for moving image. If the flash is fired at the time of still image shooting (YES in step S308), then in step S310, the WB coefficient is obtained from a final frame of the moving image RAW data recorded in the memory 30. In step S311, the WB coefficient obtained in step S310 is applied to the WB coefficient of the moving image. In step S312, the image processing circuit 20 and the compression/expansion circuit 32 encode the moving image RAW data recorded in the memory 30, to a moving image format as a moving image file by using the applied WB coefficient. In step S313, the (encoded) moving image file is recorded in the recording medium.

According to the foregoing embodiment, development processing of the still image RAW data is performed and still image data is generated. The compression/expansion circuit 32 performs compression via the memory 30. Resultant compressed data is stored in the nonvolatile memory 31. Then, the image processing circuit 20 and the compression/expansion circuit 32 perform encode processing for encoding the moving image RAW data. However, the encode processing of the moving image RAW data may be started any time as long as the WB coefficient as to the RAW data for the still image is already calculated. The encode processing of the moving image RAW data may be performed in parallel with the development processing of the still image RAW data.

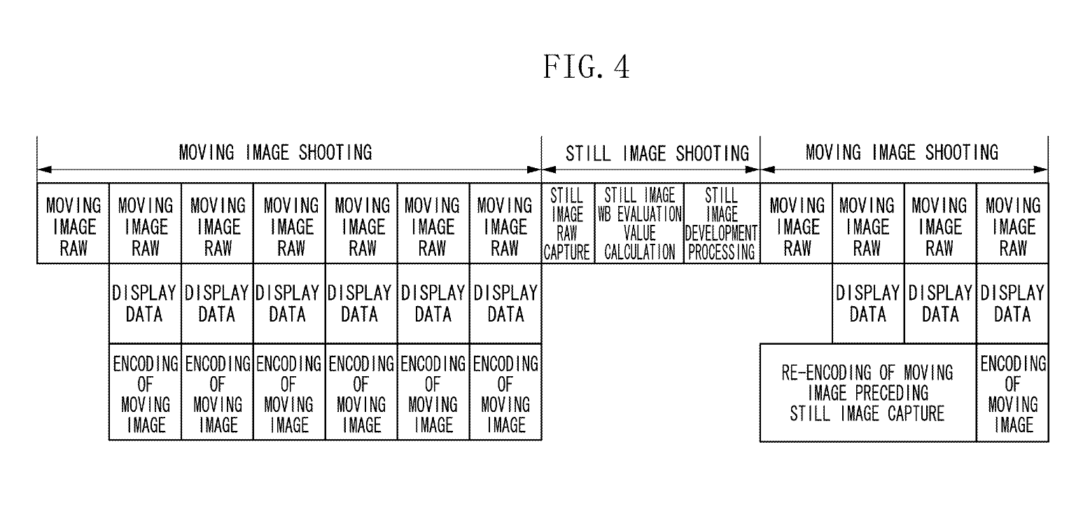

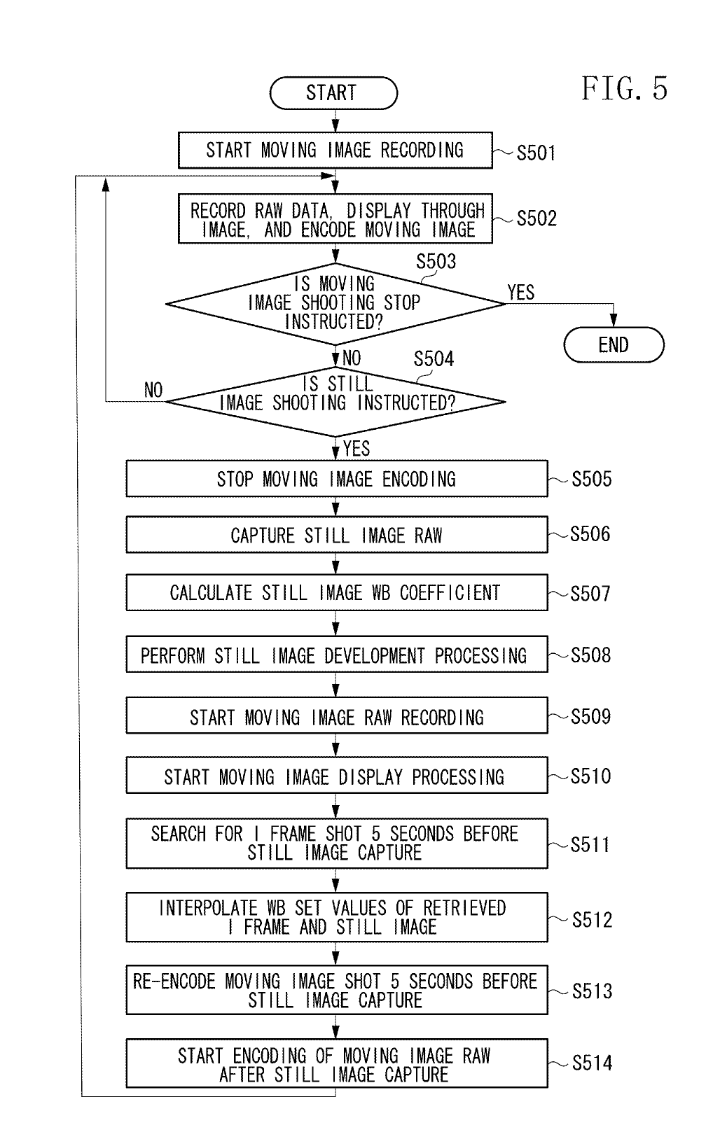

A second exemplary embodiment according to the present invention will now be described with reference to FIGS. 4 and 5. This exemplary embodiment is a case where during recording of a moving image, a still image file is also recorded in response to a user's instruction.

FIG. 4 is a diagram illustrating a sequence of the second exemplary embodiment from moving image shooting till resumption of moving image recording after still image shooting is carried out. An exemplary format of the shot moving image is the Moving Picture Experts Group (MPEG).

A first half portion of the sequence illustrates moving image shooting processing. Moving image RAW data read from the image pickup element 14 is temporarily stored in the memory 30. In the next frame, moving image RAW data of a frame next to the frame read the last time from the image pickup element 14 is temporarily stored in the memory 30. At the same time, the image processing circuit 20 converts the moving image RAW data read the last time and temporarily stored into display data, and the image display unit 28 displays the resultant display data. Simultaneously, the image processing circuit 20 and the compression/expansion circuit 32 perform moving image encode processing. These operations are repeated until still image shooting is instructed.

A middle portion of the sequence illustrates still image shooting processing started by a still image shooting instruction. If a still image shooting instruction is given, driving of the image pickup element 14 is changed and still image RAW data is stored in the memory 30 temporarily. Then, the image processing circuit 20 calculates a WB evaluation value for the still image RAW data. Then, development processing of the still image RAW data is performed by using the calculated WB evaluation value, and still image data is created. The compression/expansion circuit 32 performs compression via the memory 30. Resultant compressed data is stored in the nonvolatile memory 31.

A latter half portion of the sequence illustrates resumption processing of moving image recording after still image recording. If the moving image recording is resumed, a moving image RAW data is recorded and moving image display is resumed from the next frame. Furthermore, a moving image RAW data at specific time immediately before the still image shooting temporarily stored in the memory 30 is re-encoded at the beginning of resumption of the moving image recording. Then, moving images RAW data recorded after the resumption of the moving image recording are encoded successively.

A flow in the second exemplary embodiment will now be described with reference to FIG. 5.

First, in step S501, moving image recording is started. In step S502, a through screen is displayed while recording RAW data in the memory 30 and moving image encoding is performed. Furthermore, at the same time, with respect to an I frame, WB coefficients set at the time of moving image encoding are stored in the memory 30. In step S503, it is determined whether moving image shooting stop is instructed. If moving image shooting stop is instructed (YES in step S503), the processing is finished. If moving image shooting stop is not instructed (NO in step S503), then in step S504, it is determined whether still image shooting is instructed. If still image shooting is instructed (YES in step S504), then in step S505, the moving image encoding is stopped. In step S506, a still image RAW data is stored in the memory 30. Then, in step S507, still image WB coefficient calculation is performed. Then, in step S508, development processing of the still image RAW data is performed by using the calculated WB evaluation value to generate still image data, compression is performed in the compression/expansion circuit 32 via the memory 30, and resultant compressed data is stored in the nonvolatile memory 31.

Then, in step S509, storing the moving image RAW data in every frame in the memory 30 is started to perform processing of moving image recording resumption. Then, in step S510, moving image display processing is started. Then, in step S511, the I frame of the moving image closest to the time 5 seconds before the still image capture is retrieved. Then, in step S512, WB coefficients from the retrieved I frame to a moving image frame immediately before the still image shooting are obtained through interpolation based on the WB coefficient of the retrieved I frame included in the WB coefficients stored in the memory 30 and the WB coefficient of the still image. As for a method for interpolating coefficients, for example, a method of spline interpolation can be used. Then, in step S513, frames from the I frame retrieved in step S511 to the moving image frame immediately before the still image shooting are re-encoded based on the WB coefficients obtained in step S512. An already encoded pertinent portion of the moving image data is replaced by re-encoded moving image data.

Further, when the encoded moving image is re-encoded, I-picture frames are re-encoded based on the WB coefficient, while other picture frames such as P-picture frames are kept unchanged.

Then, in step S514, moving image encoding is started from the moving image frame resumed after still image shooting. As occasion demands, additional data indicating that the still image has been shot is successively added after the re-encoded moving image, and the moving image data encoded after the still image has been shot is successively added thereafter. Then, in step S502, operation described heretofore is repeated.

As described above, in the first exemplary embodiment, when a moving image is being recorded before still image shooting, the WB is in the course of changing to the color tone, which is the target of the WB. Accordingly, even in a case where conventionally, the color tone in the still image differs from that in the moving image, it is possible to shoot a moving image and a still image that do not cause strangeness even if the still image is compared with the moving image when, for example, the still image and the moving image before still image shooting are consecutively reproduced.

Furthermore, in the second exemplary embodiment, even when a still image is shot in the course of capturing a moving image, it is possible to capture a moving image in which the color tone changes smoothly until the still image is shot while WB is changing during moving image recording.

In the exemplary embodiments, the WB change has been described. However, the embodiments can also be applied to a change concerning another image parameter (evaluation value concerning an image quality) such as an aperture or a gamma table. Furthermore, in the second exemplary embodiment, the time of going back for WB interpolation is the time 5 seconds before still image capturing. However, another time may be used. As for the method of interpolation, instead of interpolation from certain one frame, interpolation from a plurality of frames may be used. Furthermore, the second exemplary embodiment has been described with respect to the MPEG moving image. However, the second exemplary embodiment may be applied to a moving image other than the MPEG moving image and a JPEG image. Even if the moving image is the MPEG moving image, interpolation based on a frame other than the I frame may be performed.

Heretofore, the present invention has been described in detail based on suitable exemplary embodiments. However, the present invention is not restricted to these specific exemplary embodiments. Various forms within a scope that does not depart from the spirit of the invention are also included in the present invention. Further, portions of the above-described exemplary embodiments may be suitably combined.

For example, in the embodiments, RAW image data can be replaced by JPEG image data, Motion-JPEG image data, JPEG image data, or image data in any other image data format.

Furthermore, a case is also included in the present invention where a software program that implements the function of the above-described exemplary embodiments is supplied to an image pickup device capable of executing the program directly from a recording medium or by wired/wireless communication to execute the program.

Therefore, a program code in itself that is supplied to and installed in an image pickup device to implement the functional processing of the present invention in the image pickup device realizes the present invention. In other words, the program in itself for implementing the functional processing of the present invention is also included in the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-140909, filed Jul. 8, 2014, which is hereby incorporated by reference herein in its entirety.

What is claimed is:

1. An image processing device comprising:
an acquisition unit configured to acquire RAW data for a moving image and RAW data for a still image;
a calculation unit configured to calculate an evaluation value from the RAW data for the still image;
an encoding unit configured to encode the RAW data for the moving image acquired by the acquisition unit into moving image data;
a recording unit configured to record the encoded moving image data; and
a control unit configured to, in response to an instruction to record a still image, exercise control to record the moving image data obtained during a predetermined time period before the recording instruction,
wherein the encoding unit is configured to encode the RAW data for the moving image into the moving image data, by using the evaluation value calculated from the RAW data for the still image.

2. The image processing device according to claim 1, wherein the evaluation value includes a white balance coefficient.

3. The image processing device according to claim 1, wherein when encoding the RAW data for the moving image to obtain the moving image data, a value calculated from a final frame of the RAW data for the moving image is used in a predetermined shooting condition.

4. The image processing device according to claim 3, wherein the predetermined shooting condition is a shooting with a flash light.

5. The image processing device according to claim 1, wherein, when recording a moving image is resumed after recording the still image, the moving image data encoded by the encoding unit is re-encoded.

6. The image processing device according to claim 5, wherein I-picture frames of the moving image data are re-encoded, while P-picture frames are not re-encoded.

7. An image processing method comprising:
acquiring RAW data for a moving image;
acquiring RAW data for a still image in response to an instruction to record the still image;
calculating an evaluation value from the RAW data for the still image, the RAW data for the moving image being acquired during a predetermined time period before the instruction to record the still image is given;
encoding the RAW data for the moving image to obtain the moving image data by using the evaluation value calculated from the RAW data for the still image; and
recording the encoded moving image data.

8. An image processing method comprising:
acquiring RAW data for a moving image during a predetermined time period before acquiring RAW data for a still image in response to an instruction to record the still image, by using an image processing device; and
encoding the RAW data for the moving image to obtain moving image data by using an evaluation value calculated from the RAW data for the still image by the image processing device to the RAW data for the moving image acquired by the image processing device.

9. An image processing device comprising:
an acquisition unit configured to acquire first image data and second image data;
a calculation unit configured to calculate an evaluation value from the second image data;
an encoding unit configured to encode the first image data acquired by the acquisition unit into third image data and the second image data acquired by the acquisition unit into fourth image data;
a recording unit configured to record the encoded third image data; and
a control unit configured to, in response to an instruction to record the fourth image data, exercise control to record the third image data obtained during a predetermined time period before the recording instruction,
wherein the encoding unit is configured to encode the first image data into the third image data, by using the evaluation value calculated from the second image data.

10. The image processing device according to claim 9, wherein the first image data is for a moving image and the second image data is for a still image.

11. The image processing device according to claim 9, wherein the first image data and the second image data are in a RAW image format.
